(19) United States
(12) Patent Application Publication
(10) Pub. No.: US 2006/0285216 A1
(43) Pub. Date: Dec. 21, 2006

(54) Scanning display

(76) Inventors: Akira Yamamoto, Yokohama-shi (JP); Shuichi Kobayashi, Yokohama-shi (JP); Takashi Urakawa, Kawasaki-shi (JP)

Correspondence Address: MORGAN & FINNEGAN, L.L.P., 3 World Financial Center, New York, NY, 10281-2101, US

(21) Appl. No.: 11/471,925

(22) Filed: Jun. 20, 2006

(30) Foreign Application Priority Data
Jun. 20, 2005 (JP) 2005-179930

(51) Int. Cl. G02B 27/14

(52) U.S. Cl. 359/630

(57) ABSTRACT

A scanning display includes a plurality of light sources, and a scanner for scanning lights from the plurality of light sources in two-dimensional directions, wherein the scanner scans the lights from different light sources in two or more partial scanning areas arranged in a first direction in a range corresponding to a whole scanning area, and scans, for each partial scanning area, the light at a first speed in the first direction and at a second speed higher than the first speed in a second direction different from the first direction, and wherein the scanner has the scan frequency of 10 kHz or greater in the second direction.

### BACKGROUND OF THE INVENTION

The present invention relates to a scanning display that scans a light in two-dimensional directions and enables a viewer to recognize an image.

Many retinal scanning displays have conventionally been proposed which scan a light beam from a light source in a viewer's eye or retina at a high speed, and enables him to recognize an image by utilizing an afterimage effect. One retinal scanning display synthesizes plural lights from one or more light sources into one beam, and scans the beam, as disclosed in Japanese Patent Application (“JPA”) Publication No. 2004-138822. Another type scans plural areas with plural beams, and enables the viewer to recognize one image by connecting partial images of these areas, as disclosed in JPA Domestic Publication No. 2004-527793.

A scanning device that operates at several kHz to several tens kHz is required in order to obtain a high-resolution image by scanning a light beam at a high speed, and such this type of scanning display often uses a MEMS scanning device as a micro-machine manufactured by a semiconductor process.

A higher scanning frequency of the scanning device makes its manufacture difficult. When one image is segmented into plural areas and an individual area is scanned by the plural beams from the plural light sources as disclosed in JPA Domestic Publication No. 2004-527793, a beam moving range per unit time becomes smaller than that of an apparatus that scans one entire screen with one beam as disclosed in JPA Publication No. 2004-138822, thereby lowering the scanning speed required for the beam, and lowering the scanning frequency of the scanning device while maintaining a high resolution.

However, the scanning frequency of the scanning device lowered by segmenting a whole scanning area into plural areas would highlight the noise of the scanning device, because the scanning frequency of the scanning device approximately accords with the noise frequency.

FIG. 3 shows a frequency-response characteristic of a human's acoustic sense, called a loudness curve. Understandably, for example, at a frequency between 1 and 6 kHz a human is particularly sensitive to sounds of 40 dB, which is considered to be a noise in a library. A viewer would perceive a noise of the scanning device if it is driven at the neighboring frequency, feeing uncomfortable. In addition, when a scanning display is used as an electronic viewfinder, such as a video camcorder, the generated noise is recorded.

### BRIEF SUMMARY OF THE INVENTION

It is an illustrative object of the present invention to reduce a noise of a scanning device in a scanning display that scans two or more partial scanning areas by using plural light sources and enables one image to be recognized.

A scanning display according to one aspect of the present invention includes a plurality of light sources, and a scanner for scanning lights from the plurality of light sources in two-dimensional directions, wherein the scanner scans the lights from different light sources in two or more partial scanning areas arranged in a first direction in a range corresponding to a whole scanning area, and scans, for each partial scanning area, the light at a first speed in the first direction and at a second speed higher than the first speed in a second direction different from the first direction, and wherein the scanner has the scan frequency of 10 kHz or greater in the second direction.

An imaging apparatus that includes the above scanning display, an image display system that includes the above scanning display and an image supply unit also constitute another aspect of the present invention.

Other objects and further features of the present invention will become readily apparent from the following description of the preferred embodiments with reference to the accompanying drawings.

### BRIEF DESCRIPTION OF THE DRAWINGS

FIG. 1 is a schematic view showing a structure of a scanning display according to a first embodiment of the present invention.

FIG. 2 is a schematic view showing an illustrative two-dimensional scanning device.

FIG. 3 is a graph of a loudness curve.

FIG. 4 is a view for explaining reciprocating scanning in a high-speed scanning direction according to the first embodiment.

FIG. 5 is a driving waveform diagram of a scanning device in a low-speed direction according to the first embodiment.

FIG. 6 is another driving waveform diagram of the scanning device in a low-speed direction according to the first embodiment.

FIG. 7 is still another driving waveform diagram of the scanning device in a low-speed direction according to the first embodiment.

FIG. 8 is a view showing a scanning spot's movement on a retina.

FIG. 9A is a view for explaining a cause of an image loss due to eyeball motions, and FIG. 9B is a view for explaining the image loss.

FIG. 10 is a schematic view of a structure of a scanning display according to a sixth embodiment of the present invention.

FIG. 11 is a table showing parameters of the scanning displays according to the first to seventh embodiments.

FIG. 12 is a view of a head mount display using the scanning display according to one of the embodiments.

FIG. 13 is a video camcorder using an electronic viewfinder using the scanning display according to one of the embodiments.

### DETAILED DESCRIPTION OF THE PREFERRED EMBODIMENTS

Referring now to the accompanying drawings, a description will be given of a preferred embodiment of the present invention.

### First Embodiment

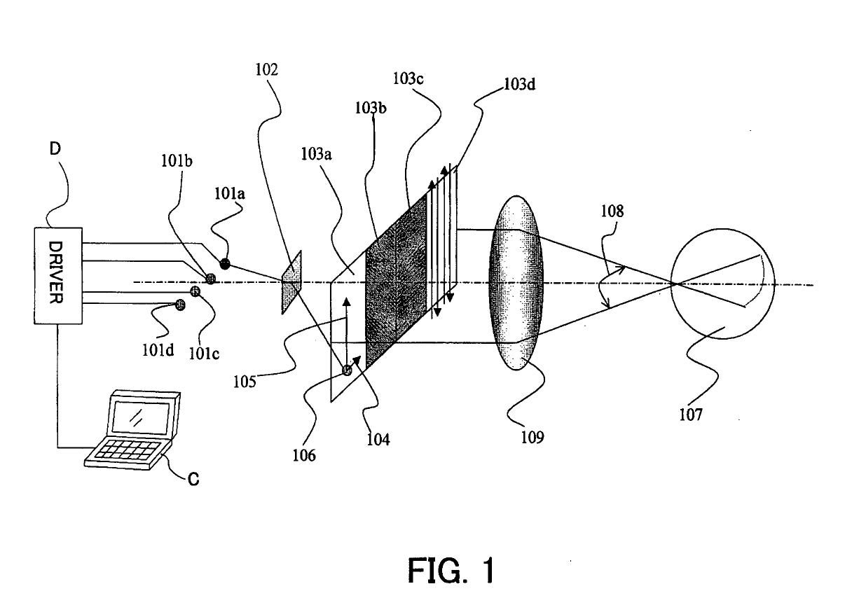

FIG. 1 shows a schematic structure of a scanning display according to a first embodiment of the present invention. The scanning display is used for a head mount display that is attached to a viewer's head and enables him to view motion and still images. Alternatively, the scanning display may be mounted as electronic viewfinder in a video camcorder and a digital camera.

In FIG. 1, 101a to 101d denote light sources, such as an LED, a laser diode, and a lamp. 102 denotes a scanning device (or a scanner) that scans the lights from the light sources 101a to 101d in two-dimensional directions. The scanning device of this embodiment includes a rotatable plane mirror. 109 denotes an ocular optical system (eyepiece) that magnifies a beam to be scanned by the scanning device 102, and introduces the beam to a viewer's eye or retina 107.

For simplified description, FIG. 1 omits an optical system that converts a divergent light from the light source into an approximately collimated beam, or an optical system that images the beam on a scanned plane 103. This applies to the following embodiments:

Four light sources 101a to 101d are connected to a driver D, which receives an image signal from an image supply unit, such as a personal computer (“PC”), a DVD player, and a VCR. The driver D segments one (field) image into four areas in a horizontal direction, and modulates the lights from four light sources 101a to 101d in accordance with image signals of these four segmented areas. The following embodiments also receive these image signals and control modulations of the light sources.

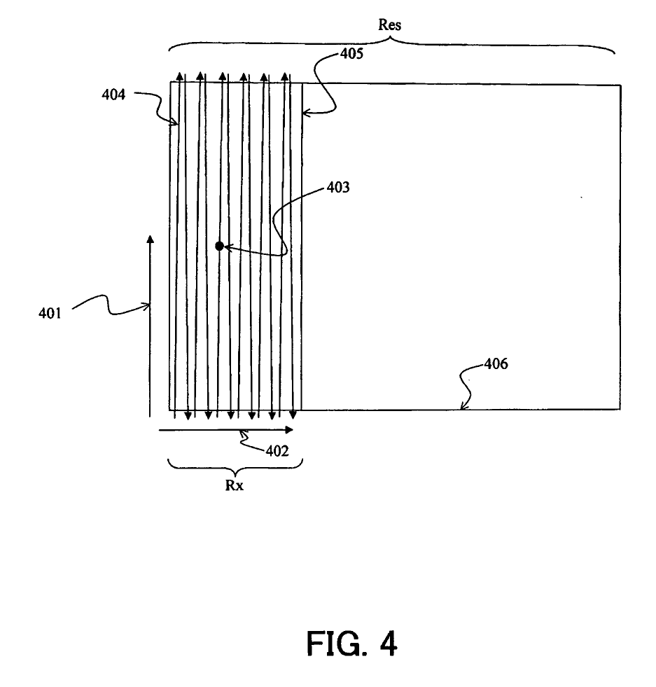

Four beams emitted from the four light sources 101a to 101d form spots on the scanned plane 103 that corresponds to one screen (whole scanning area). Due to the beam deflecting operations of the scanning device 102, four spots 106 (although FIG. 4 shows only one spot) are scanned in the two-dimensional directions (i.e., a horizontal direction 104 and a perpendicular direction 105) in each of the four partial scanning areas 103a to 103d that are adjacent to each other in the horizontal direction on the scanned plane 103. The four beams that have passed the scanned plane 103 form a spot on the retina in the eye 107 via the ocular optical system (eyepiece) 109. Each spot on the retina moves in the two-dimensional directions as each beam is scanned in the two-dimensional directions.

The viewer can recognize four split images corresponding to four partial scanning area 103a to 103d due to the afterimage effect of the four spots. When recognizing the four horizontal split images during a period of the afterimage effect, he can recognize or view one image that connects the four split images. As the ocular optical system (eyepiece) 109 magnifies the four partial scanning areas 103a to 103d, the viewer can view the image having a predetermined view angle (overall angular field of view) 108 in the horizontal direction.

The scanning device 102 scans the beam in each partial scanning area at a predetermined speed (or fist speed) in the horizontal direction 104 and at a (second) speed higher than the predetermined direction.

This embodiment uses, for the scanning device 102, a two-dimensional scanning device in which a single device can scan in the two-dimensional directions.

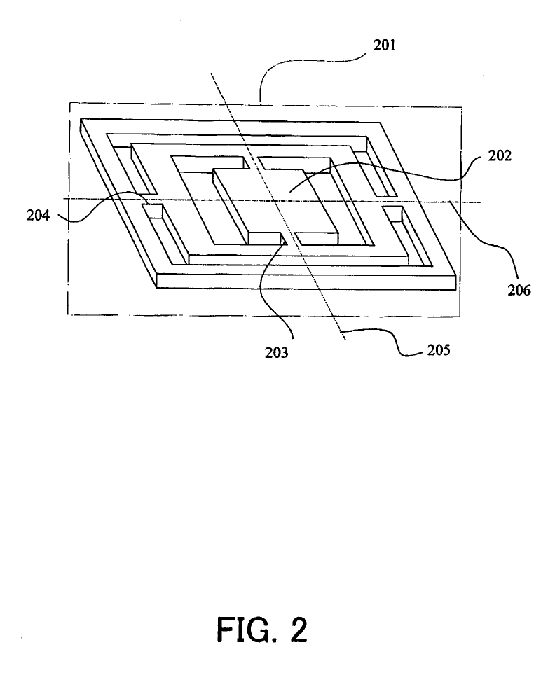

A scanning device 201 shown in FIG. 2 is a micro-electro mechanical systems (“MEMS”) device manufactured by the semiconductor process technology. The scanning device 201 is configured such that torsion bars 203 and 204 support a fine mirror 202 including a deflecting plane (reflecting surface). The fine mirror 202 provides resonance reciprocating motions around an axis 205 as an approximate center as the torsion bar 203 twists, and resonance reciprocating motions around an-axis 206 as an approximate center as the torsion bar 204 twists. The reciprocating motions around both the axes 205 and 206 as approximate centers two-dimensionally change a normal direction of the deflecting plane of the fine mirror 202. Thereby, a reflecting direction of the beam incident upon the fine mirror 202 changes, and the beam can be scanned in the two-dimensional directions.

Use of such a MEMS device would be able to maintain small the scanning device 102.

Another scanning means may be used instead of the above two-dimensional MEMS scanning device. For example, a combination of two one-dimensional MEMS scanning devices each of which can one-dimensionally scan may be used with their scanning directions different, and a combination of a one-dimensionally scanning, rotational polygon mirror and a one-dimensional MEMS scanning device may be used.

The scanning frequency of the MEMS scanning device approximately accords with the frequency of the noise generated from the scanning device. Therefore, setting of the scanning frequency in a perpendicular direction as a high-speed scanning direction, which is higher than scanning in the horizontal direction, to a frequency less audible or inaudible to the human ear would be able to particularly prevent perception of the noise generated from the scanning device.

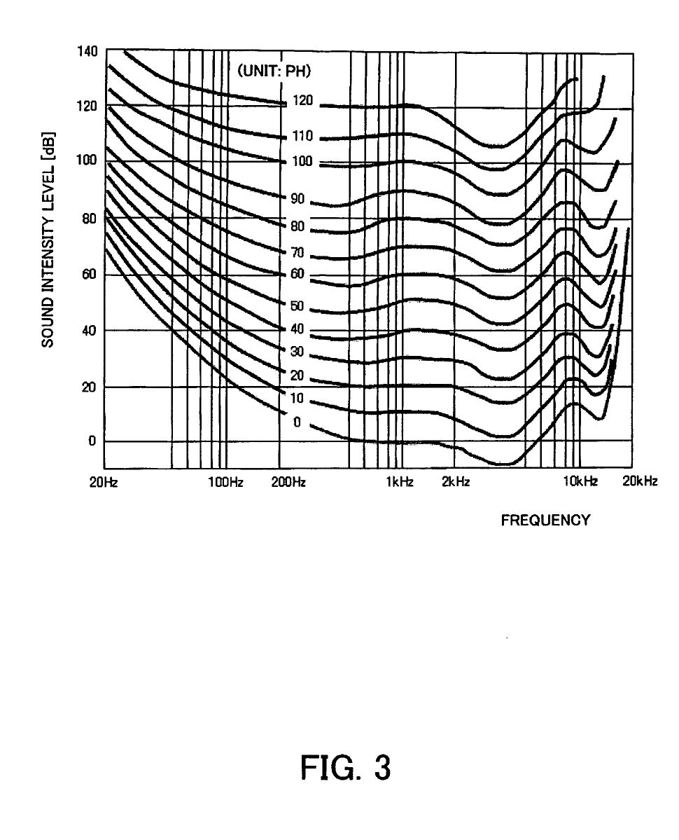

The frequency-response characteristic of the human's acoustic sense is the loudness curve shown in FIG. 3. As understood from the loudness curve, the human's acoustic sense is most sensitive, for example, to a sound of 40 dB, which amounts to a noise in a library, at a frequency between 1 kHz and 6kHz. Conversely, when the scanning device acts in this range of frequency, the noise at a reference frequency in this range is generated and perceived.

In order to make this noise less audible in view of the human's acoustic sense sensitivity, the scanning frequency of the scanning device is set preferably to 10 kHz or greater, more preferably to 15 kHz or greater.

For this purpose, the scanning frequency in the high-speed scanning direction should meet the following conditional equation (1). The derivation will be described with reference to FIG. 4, where Freq is a scanning frequency in the high-speed scanning frequency. FIG. 4 shows one partial scanning area 405 on a scanned plane 406. The partial scanning area 405 is scanned at a high speed in a perpendicular direction 401, and scanned at a low speed in a horizontal direction 402. 403 denotes a spot on the scanned plane 406, and 404 denotes a locus of the spot 403.

An image resolution Rx in one partial scanning area is expressed as Rx=Res/Z, where Res is an image resolution on the entire screen in the low-speed scanning direction (horizontal direction), and Z is the number of partial scanning areas in the low-speed scanning direction. The same number of (scanning) lines is necessary to completely display the resolution Rx (or enable this resolution Rx to be recognized). Then, reciprocating scanning in the high-speed scanning direction or beam scanning in both outward and return paths during one scanning period requires Rx/2 times high-speed scanning during the beam scanning for one frame image. A scanning time period T for one frame is expressed as T=1/(α×FR), where FR is a scanning frequency in the low-speed scanning direction and α is a constant (which will be discussed later).

The scanning frequency Freq in the high-speed scanning direction is expressed as Freq=Rx/2×1/T=α×FR×10⁻³×{Res/(2×Z)}(kHz)

In order for Freq to exceed 10 kHz, the following equation is derived:
10≦(α×Res×FR)×10⁻³/(2×Z) (1)

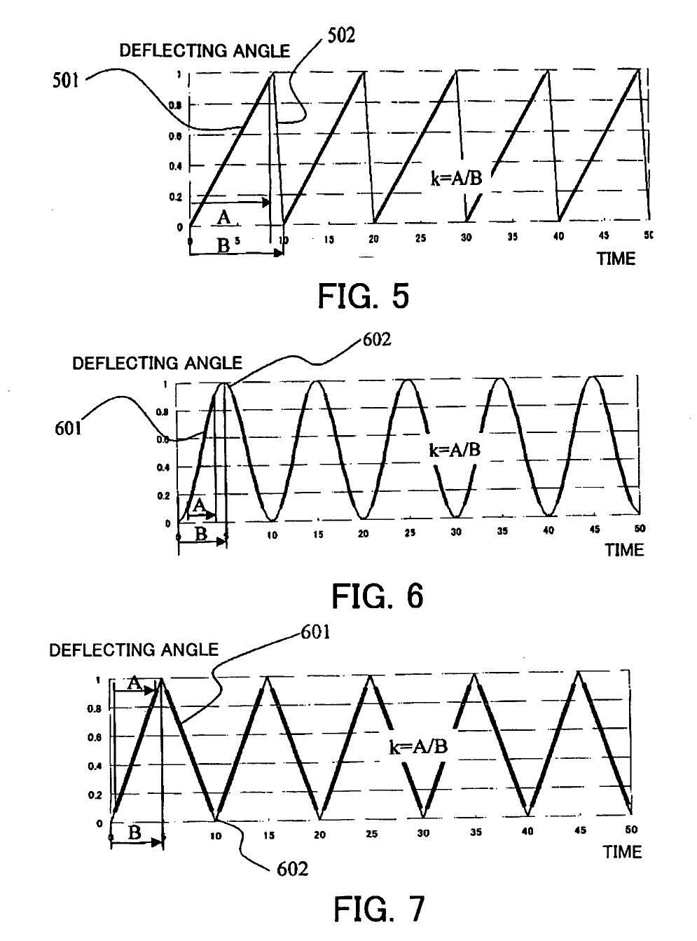

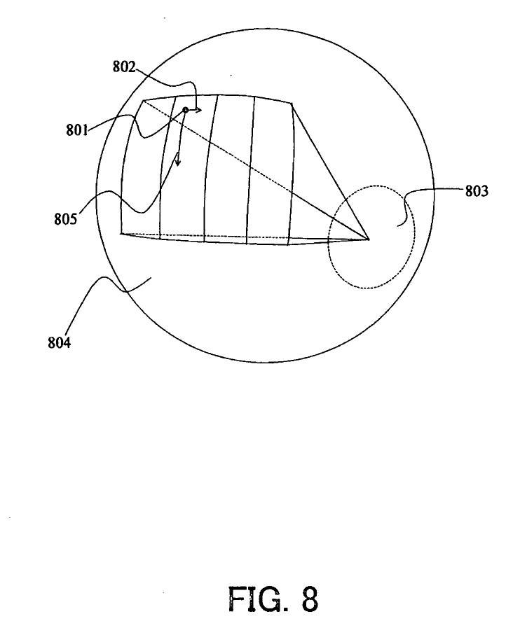

The equation (1) would restrain the noise from the high-speed scanning. When the conditional equation (1) does not satisfy the lower limit, the noise remains since the noise frequency caused by the high-speed scanning is likely to be audible to the human. In addition, an excessively high frequency of the high-speed scanning would make manufacture of the scanning device difficult. Thus, Freq=(α×Res×FR)×10⁻³/(2×Z)−≦200 is met preferably, where a is an effective scanning period in one “nominal” scanning period of the scanning device 102 in the low-speed scanning direction (where one scanning period is defined as a driving time period starting reciprocation with one end and ending with the one end after reaching the other end) or a constant relating to an effective scanning period. For example, α=1/k is met where the fine mirror reciprocates in a saw tooth waveform shown in FIG. 5 in the low-speed scanning direction, while the beam is scanned at a time period 501 shown by a thick line in the outward path, and the beam is stopped during the fly-back time 502 in the return path. α=2/k is met where the fine mirror reciprocates in a sine waveform (FIG. 6) and triangle waveform (FIG. 7), while the beam is scanned in a time period 601 shown by a thick line in both the outward and return paths.

In FIGS. 5, 6 and 7, the abscissa axis denotes time, and the ordinate axis denotes a deflecting angle of the fine mirror (where 0 denotes one end and 1 denotes the other end in the reciprocating driving). During time periods 502 and 602 indicated by a thin line, the fine mirror is driven, but none of the light sources emit, and no beam scanning is conducted.

“k” denotes a ratio of an effective scanning period in one “nominal” scanning period, and is also referred to as time use efficiency. In the saw tooth waveform driving shown in FIG. 5, k=A/B is met where A is the effective scanning period in one “nominal” period, and B is one period.

A range of k meets 0.5≦k≦1. A range of ax is as follows in accordance with the driving waveform in the low-speed scanning direction:
1≦α≦2 (saw tooth waveform driving); and
2≦α≦4 (triangle or sine waveform driving).

When α (or k) becomes lower than the lower limit in the above range, the emitting time period of the light source becomes so short that a viewed image becomes dark and unsuited to practical use.

In this embodiment in which the low-speed scanning is the horizontal direction and the high-speed scanning is the perpendicular direction, a scanning frequency Freq of the high-speed scanning direction (or perpendicular direction) satisfies as follows, where the total Res of pixels in the horizontal direction is 800 pixels, the number Z of partial scanning areas in the horizontal direction is 4, the scanning device 102 is driven in a triangle waveform in the low-speed scanning direction, the scanning frequency FR in the low-speed scanning direction is 60 Hz, and the constant α in the low-speed scanning direction is 2.5 (=2/k: time use ratio k=0.8):

$$\begin{matrix}Freq = ( α ⨯ Res ⨯ FR ) ⨯ {10}^{- 3} / ( 2 ⨯ Z ) \\ = 2.5 ⨯ 800 ⨯ 60 ⨯ {10}^{- 3} / ( 2 ⨯ 4 ) \\ = 15 ( kHz )\end{matrix}$$

Thus, Freq becomes 10 kHz or greater (and 15 kHz or greater).

Thereby, the frequency of the noise of the scanning device 102 can become less audible to the human.

The scanning frequency of the scanning device 102 in the low-speed scanning direction can be calculated based on the following rule. Assume that the scanning frequency in the low-speed scanning direction is 60 Hz, and the whole view angle is 24° in the low-speed scanning direction. Also assume that the fine mirror in the scanning device 102 is driven and reciprocated in a triangle waveform shown in FIG. 7 in the low-speed scanning direction, and the viewer's eyeball does not move. Then, a moving angular speed of a spot 801 is 360°/sec in a low-speed scanning direction 802 on a retina 804 in the eyeball shown in FIG. 8. In FIG. 8, 803 denotes a pupil of the eye, and 805 denotes a high-speed scanning direction.

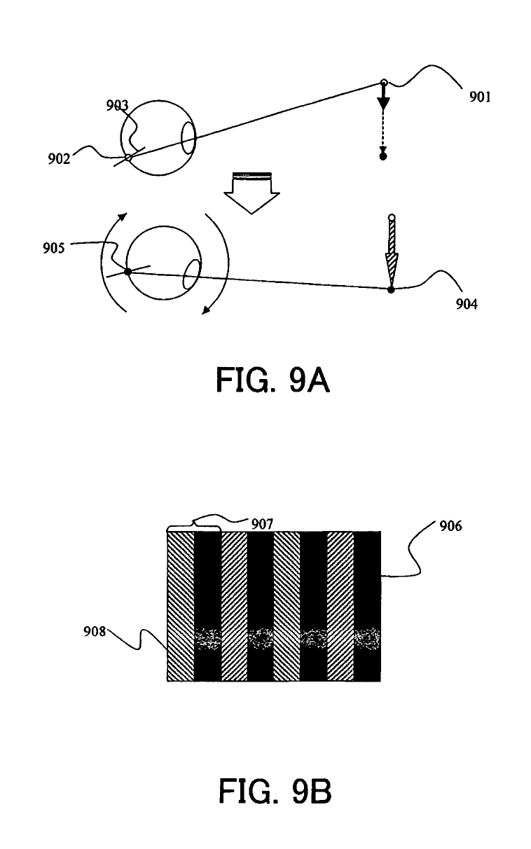

On the other hand, as disclosed in Satoshi Kobori, Ryukoku University, Physiological System, Nr. 5, “Visual System and Acoustic System 1,” http://milan.elec.ryukoku.ac.jp/%7Ekobori/resume/bio/bi o5.html, a human's eyeball moves at 300°/sec to 600°/sec in the saccade, and the field of view changes at the same angular speed. When the moving angular speed of a spot 902 on a retina is slower than the field changing angular speed by the saccade as shown in FIG. 9A, the spot 902 appears to relatively stop on the retina or move in the reverse direction. A top view of FIG. 9A shows that the spot 902 corresponding to a spot 901 on the scanned plane at a predetermined time forms at a point 903 on the retina. A bottom view of FIG. 9B shows a position of a spot 905 on the retina as the eyeball rotates in the same direction as the moving direction of a spot 904 on the scanned plane from the state of the top view.

In that case, a viewer does not acquire a continuous afterimage effect, and perceives a drop in an image (image drop) 906 shown in FIG. 9B. The viewer recognizes an image at a position 908 in each partial scanning area 907, but cannot recognize an image at the position of the drop 906.

In order to eliminate the image drop, the moving angular speed of the spot on the retina should exceed the oculomotor angular speed. The following equation is established where Z is the number of partial scanning areas arranged in the low-speed scanning direction or an entire angular field of view, Fov is an entire view angle in the low-speed scanning direction, FR is a scanning frequency in the low-speed scanning direction, and Vt is a moving angular speed of the spot on the retina:
Vt=Fov/Z×(α×FR) (2)

This speed should always exceed the moving angular speed (ω=300°/sec to 600°/sec) of the field of view in the saccade state. This embodiment uses the field's maximum moving angular speed of 600°/sec by the saccade, and obtains the following equations:
(α×Fov×FR)/Z≧600 (=ω); or
FR≧(600×Z)/(α×Fov) (3)

Where Z=4, Fov=24, and α=2.5 in the triangle waveform driving, FR≧(600×4)/(2.5×24)=40 (Hz) is met as described above:

Where the scanning frequency in the low-speed scanning direction (or the horizontal direction) is 40 Hz or greater, the image drop is reduced or eliminated. Therefore, use of the scanning frequency FR of 60 Hz in the low-speed scanning direction, which is used to introduce the scanning frequency Freq in the high-speed scanning direction, would be able to reduce or eliminate the image drop.

While this embodiment sets a value of ω in the equation (3) to 600°/sec, any value may be set from a range between 300°/sec and 600°/sec, such as 400°/sec, 500°/sec, and 550°/sec.

In addition, while this embodiment sets both the light sources and partial scanning areas to four, the present invention does not limit these numbers to four, and may select any number equal to or greater than two. The present invention is not limited to this embodiment in which the number of light sources is equal to the number of partial scanning areas. The number of light sources may be different from the number of partial scanning areas. For example, the lights from three-color (or red, green and blue) light sources are synthesized into one beam, and plural composite beams may be used to scan plural partial scanning areas.

Moreover, while this embodiment arranges four partial scanning areas adjacently and closely, the present invention may set the partial scanning areas so that they partially overlap each other.

### Second Embodiment

In the second embodiment of the present invention, the horizontal view angle Fov is 24°, the horizontal resolution Res is 800 pixels, and the number Z of the partial scanning areas is 12 in the horizontal direction. The scanning display is configured similar to that of the first embodiment (FIG. 1), and common elements are designated by the same reference numerals as those in the first embodiment.

In this embodiment, the low-speed scanning direction is the horizontal direction. In the low-speed scanning direction, the scanning device 102 is driven in a sine waveform. The constant a is 2.5 (time use efficiency k=0.8), and the frequency FR is 120 Hz.

Then, the scanning frequency Freq in the high-speed scanning direction (perpendicular direction) is expressed as Freq=(α×Res×FR)×10⁻³/(2×Z)=10 (kHz), and satisfies the equation (1). Thus, the noise from the high-speed scanning of the scanning device 102 has a frequency less audible to the human. In order to make the frequency much less audible, the scanning frequency of the low-speed scanning direction (horizontal direction) should be set to a higher frequency, such as 180 Hz. When it is set to 180 Hz, the frequency of the high-speed scanning becomes higher or 15 kHz as follows:

Freq=(α×Res×FR)×10⁻³/(2×Z)=15 (kHz) Therefore, it becomes less audible to the human than 10 kHz.

From the equation (3), the lower limit of the scanning frequency FR in the low-speed scanning direction (horizontal direction) is expressed as FR≧(600×12)/(2/0.8×24)=120 (Hz). Therefore, no image drops occur when either 120 Hz or 180 Hz is selected for the scanning frequency in the low-speed scanning frequency.

### Third Embodiment

The third embodiment of the present invention discusses a scanning display that sets, similar to the first embodiment, a low-speed scanning direction to the horizontal direction, and the number of pixels in the low-speed scanning direction to 2,160 pixels. Since the minimum resolution of the human eye is about 1 minute, the minimum resolution of the human eye accords with a size of one pixel when the horizontal view angle is 36°. Accordingly, this embodiment sets the horizontal view angle (or the entire angular field of view in the low-speed scanning direction) to 36°. The scanning display is configured similar to that of the first embodiment (FIG. 1), and common elements are designated by the same reference numerals as those in the first embodiment.

Assume that the number Z of partial scanning areas is 3 in the low-speed scanning direction, and the scanning device 102 is driven in a saw tooth waveform in the low-speed scanning direction. Also assume that the frequency FR is 60 Hz, and the constant a is 1.25 (=1/k: time use efficiency k=0.8). Since the resolution Res is 2,160 pixels in the low-speed scanning direction, the scanning frequency Freq in the high-speed scanning direction (perpendicular direction) satisfies the equation (1) as follows:

Freq=(α×Res×FR)×10⁻³/(2×Z)=27 (kHz) Thus, the noise from the scanning device 102 in the high-speed scanning direction (or perpendicular direction) has a frequency less audible to the human.

Thus, this embodiment sets the scanning frequency to 60 Hz in the low-speed scanning direction, the scanning frequency to 27 kHz in the high-speed scanning direction.

### Fourth Embodiment

The fourth embodiment of the present invention discusses a scanning display that sets, similar to the first embodiment, a low-speed scanning direction to the horizontal direction, and has a wide view angle of 80° in the horizontal direction (or the entire angular field of view in the low-speed scanning direction). The scanning display is configured similar to that of the first embodiment (FIG. 1), and common elements are designated by the same reference numerals as those in the first embodiment.

Assume that the scanning device 102 is driven in a saw tooth waveform in the low-speed scanning direction, the frequency FR is 40 Hz, and the constant α is 2.5 (time use efficiency k=0.8). Where the resolution Res is 3,840 pixels in the low-speed scanning direction and the number Z of the partial scanning areas is 10, the scanning frequency Freq in the high-speed scanning direction (perpendicular direction) satisfies the equation (1) as follows:
Freq=(α×Res ×FR)×10⁻³/(2×Z)=19.2 (kHz)
Thus, the noise generated from the high-speed scanning of the scanning device 102 has a frequency less audible to the human.

From the equation (3), the lower limit of the scanning frequency FR meets FR≧(600×10)/(2.5×80)=30 (Hz) in the low-speed scanning direction (horizontal direction) When the scanning frequency FR is 40 Hz in the low-speed scanning direction, no image drops occur. Since the frequency of 30 Hz is likely to cause so-called flickers, which appear as blinking images to the human eyes, a preferable scanning frequency in the low-speed scanning direction is 40 Hz or greater.

### Fifth Embodiment

The fifth embodiment of the present invention discusses scanning in the perpendicular direction slower than that in the horizontal direction. The scanning display is configured similar to that of the first embodiment (FIG. 1), and common elements are designated by the same reference numerals as those in the first embodiment.

This embodiment sets a horizontal view angle to 80°, and an aspect ratio of the screen to 16: 9. Plural partial scanning areas are arranged in the low-speed scanning direction as the perpendicular direction, the scanning device 102 is driven in a triangle waveform in the low-speed scanning direction, and the constant a is 2.5 (time use efficiency k=0.8).

When the number of horizontal pixels is 3,840 pixels, the number Res of perpendicular pixels is 2,160 pixels, and the perpendicular view angle FR is 45°. When the number Z of the partial scanning areas is 5 in the low-speed scanning direction (perpendicular direction) and the scanning frequency FR is 45 Hz, the scanning frequency Freq in the low-speed scanning direction (horizontal direction) satisfies the equation (1) as follows:
Freq=(α×Res×FR)×10⁻³/(2×Z)=24.3 (kHz)
Thus, the noise generated from the high-speed scanning of the scanning device 102 has a frequency less audible to the human.

From the equation (3), the lower limit of the scanning frequency FR in the low-speed scanning direction (perpendicular direction) is as follows:
FR≧(600×5)/(2.5×45)=26.7 (Hz)
When the scanning frequency FR in the low-speed scanning direction is 45 Hz, no image drops occur.

### Sixth Embodiment

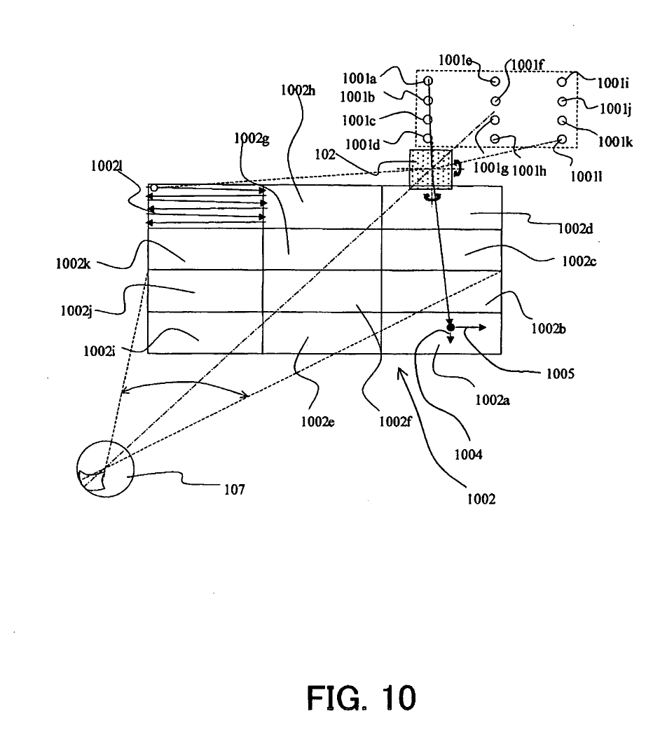

FIG. 10 shows a schematic structure of a scanning display according to a sixth embodiment of the present invention. This embodiment will discuss partial scanning areas that are arranged two-dimensionally, i.e., like a tile arrangement in the horizontal and perpendicular directions, instead of partial scanning areas that are arranged one-dimensionally or only in the low-speed scanning direction as in the first to fifth embodiments.

In FIG. 10, 1001a to 10011 denote twelve light sources, such as an LED, a laser diode, and a lamp. 102 denotes a scanning device that two-dimensionally scans the beams from the light sources 1001a to 10011, and uses a two-dimensional MEMS scanning device, similar to the first embodiment.

As described for the first embodiment, FIG. 10 omits an optical system that converts a divergent light from the light source into an approximately collimated beam, an optical system that images the scanned beam on a scanned plane 1002, or an ocular optical system (eyepiece) for magnifying and introducing the scanned plane 1002 to the viewer's eyes.

The scanning device 102 scans plural beams from the light sources 1001a to 10011 in the partial scanning areas 1002a to 10021. This embodiment sets scanning in the perpendicular direction slower than that in the horizontal direction.

This embodiment sets a horizontal view angle Fov to 120°, and an aspect ratio of the screen to 16:9. The scanning device 102 is driven in saw tooth waveform in the low-speed scanning direction, and the constant a is 1.25 (time use efficiency k=0.8). The number of partial scanning areas is 3 in the horizontal direction, 4 in the perpendicular direction, i.e., totally 12. In other words, the number Z of the partial scanning areas in the low-speed scanning direction is 4. The scanning frequency FR is 60 Hz in the low-speed scanning direction (perpendicular direction). The number of horizontal pixels is 6,400 pixels, the number Res of perpendicular pixels is 6,400/16 ×9=3, 600 pixels, and the perpendicular view angle FR is 67.5°.

The scanning frequency Freq in the high-speed scanning direction (horizontal direction) satisfies the equation (1) as follows:
Freq=(α×Res×FR)×10⁻³/(2×Z)=33.8 (kHz)
Thus, the noise from the high-speed scanning of the scanning device 102 has a frequency is less audible to the human.

From the equation (3), the lower limit of the scanning frequency FR in the low-speed scanning direction (perpendicular direction) is as follows:
FR≧(600×4)/(1.25×67.5)=28.4 (Hz)
When the scanning frequency FR is 60 Hz in the low-speed scanning direction (perpendicular direction), no image drops occur.

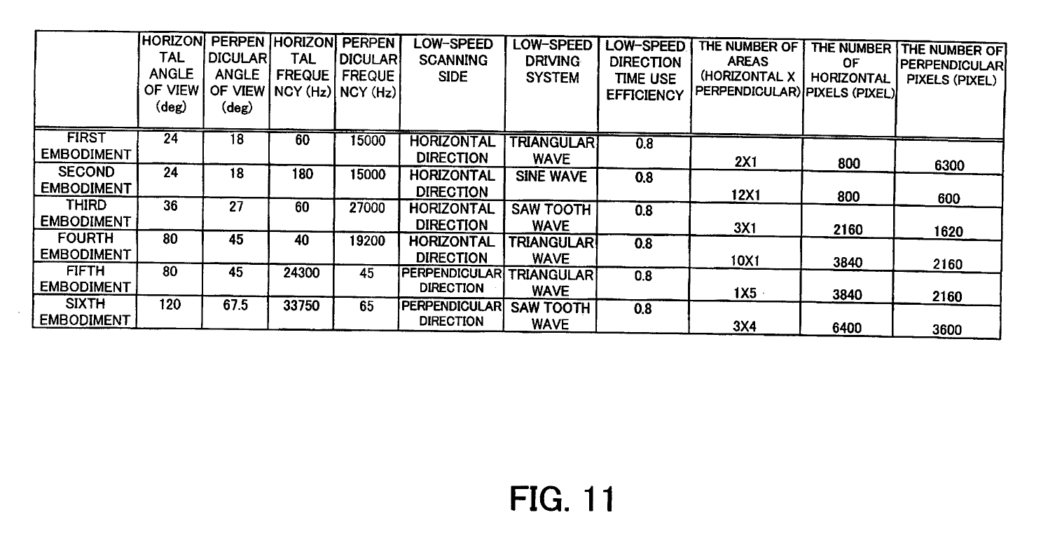

FIG. 11 lists parameters of the scanning displays according to each embodiment.

As discussed above, each embodiment sets a frequency of a noise from high-speed scanning of the scanning means to one that is less audible or inaudible to a viewer. These embodiments eliminate unpleasant, large noises from the viewer, and prevent recording of the noise from the scanning means.

### Seventh Embodiment

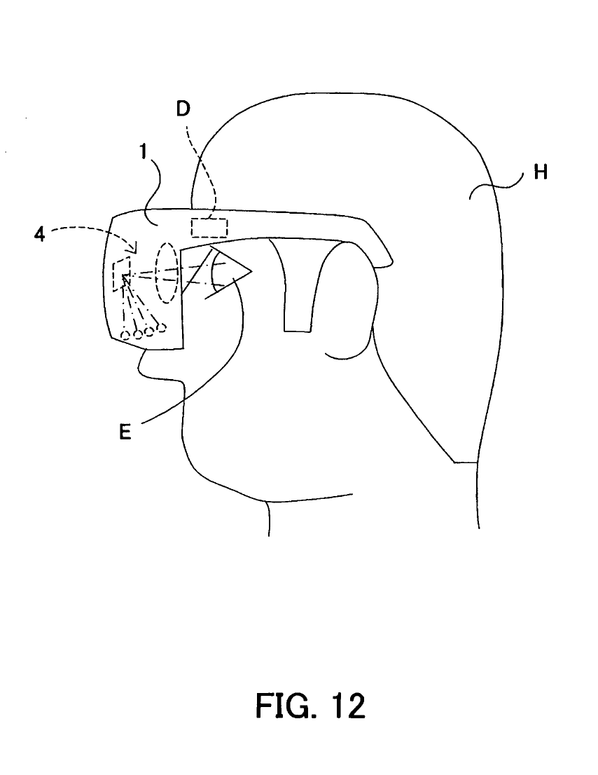

FIG. 12 is a head mount display that uses a scanning display described in any one of the first to sixth embodiments. The head mount display 1 is mounted on the viewer's head H and used like glasses. A display body in which the scanning display 4 is installed is arranged before the viewer's eyes E. Although not shown, one scanning display 4 is assigned to each viewer's eye.

The head mount display 1 is mounted with a driver D also shown in FIG. 1, which is connected to an image supply unit (see FIG. 1).

A beam emitted from the scanning display 14 scans the retina in the viewer's eyes E in accordance with the image signal from the image supply unit.

### Eighth Embodiment

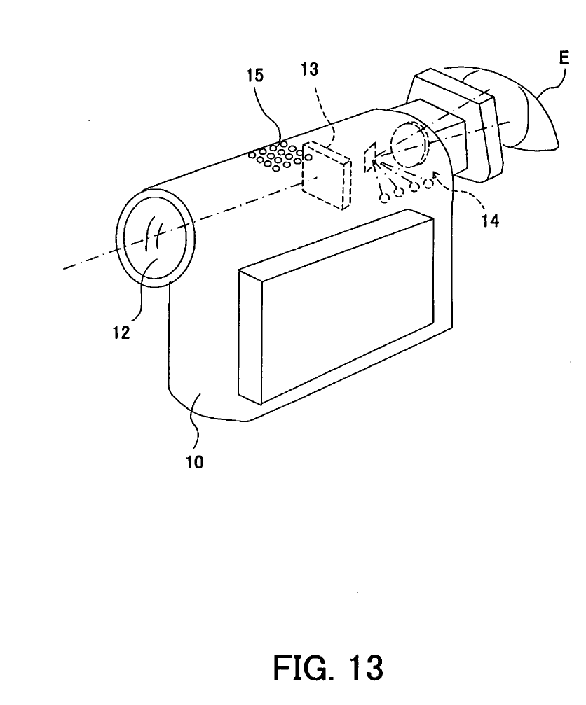

FIG. 13 shows a video cam encoder using a scanning display described in one of the first to sixth embodiments. The video camcorder 10 includes an image taking lens 12, an image pickup device 13, such as a CCD sensor and a CMOS sensor, which photoelectrically converts a subject image formed by the image taking lens 12, and a microphone 15 that records a sound during recording.

The video camcorder 10 further includes a scanning display 14 as an electronic viewfinder for enabling a viewer to view an image obtained by the image pickup device 13.

The viewer (or photographer) can view the subject or confirm the shot image when a beam emitted from the scanning display 14 scans the retina in the viewer's eye E in accordance with the image signal obtained from the image pickup device 13.

This application claims a foreign priority benefit based on Japanese Patent Applications No. 2005-179930, filed on Jun. 20, 2005, which is hereby incorporated by reference herein in its entirety as if fully set forth herein.

What is claimed is:

1. A scanning display comprising:
a plurality of light sources; and
a scanner for scanning lights from the plurality of light sources in two-dimensional directions,
wherein said scanner scans the lights from different light sources in two or more partial scanning areas arranged in a first direction in a range corresponding to a whole scanning area, and scans, for each partial scanning area, the light at a first speed in the first direction and at a second speed higher than the first speed in a second direction different from the first direction, and
wherein said scanner has the scan frequency of 10 kHz or greater in the second direction.

2. A scanning display according to claim 1, wherein said scanner has a scanning frequency of 15 kHz or higher.

3. A scanning display according to claim 1, wherein 10≦(α×Res×FR)×10⁻³/(2×Z) is met, where Res is a resolution of an image in the first direction, FR is a scan frequency (Hz) in the first direction, Z is the number of partial scanning areas arranged in the first direction, and a is a constant relating to an effective period in one scan period in the first direction.

4. A scanning display according to claim 1, wherein said scanning display scans the lights relative to eyes of a viewer.

5. An image pickup apparatus comprising a scanning display according to claim 1 for displaying a captured image.

6. An image display system comprising:
a scanning display according to claim 1; and
an image supply unit for supplying an image signal to said scanning display.
